(19) United States
(12) Patent Application Publication
(10) Pub. No.: US 2005/0000636 A1
(43) Pub. Date: Jan. 6, 2005

(54) Method for temporarily fixing two planar workpieces

(76) Inventors: Bruno Geiger, Daisendorf (DE); Stefan Furst, Aalen (DE); Daniel Kappes, Engen (DE); Jurgen Hoppner, Ratingen (DE)

Correspondence Address: PERMAN & GREEN, 425 POST ROAD, FAIRFIELD, CT, 06824, US

(21) Appl. No.: 10/839,855

(22) Filed: May 6, 2004

(30) Foreign Application Priority Data
May 7, 2003 (DE) 103 20 375.3-33

(51) Int. Cl. B32B 31/00

(52) U.S. Cl. 156/247; 156/275.5

(57) ABSTRACT

The present invention relates to a method for temporarily fixing two planar workpieces, in particular a processed wafer and a carrier wafer. A thin layer is first applied to the sides of the two workpieces that have to be connected, and the coated sides of the workpieces are then connected by means of a bonding agent. Care should be taken that the thin layers can preferably be applied easily and removed without leaving any residues. The bonding agent, which actually causes the bond, needs only be selected with respect to its chemical resistance and its mechanical and adhesive properties.

The invention relates to a method for temporarily fixing two planar workpieces, in particular a processed wafer and a carrier wafer.

In the course of the manufacture of, e.g. optoelectronic or power semiconductors, the thickness of the substrate or wafer must be reduced considerably in successive grinding, lapping and etching processes after the front surface thereof has been treated. Because of the fragility of these so-called “thin wafers”, carrying techniques are used in which the treated wafer, in the following called processed wafer, is bonded to a carrier wafer or carrier, so that the resulting stack or sandwich can be treated safely without the risk of fracture. Processed wafer and carrier are subsequently released from each other by means of suitable processes, and the processed wafer is supplied to the final sawing and packaging processes.

Due to the rigid demands placed on the wafer stack with respect to resistance against mechanical and chemical stress, known methods for placing the processed wafer on the carrier wafer make use of bonding agents which can only be applied in thermocompression methods. Bonding techniques of this kind must therefore be carried out on heated presses or bonders. It is a considerable problem in known methods that after separation of processed wafer and carrier wafer, the bonding agent has to be removed from the processed wafer without leaving any residues. This aim clearly contradicts the demand for a high resistance to chemical attacks of the wafer stack.

From DE 100 55 763 A1 and the post-published DE 101 56 465 C1 it is known to connect a processed wafer and a carrier wafer releasably by means of a spin-on glass, wherein the surfaces of the wafers are coated with SiN or SiO₂.

It is known from DE 197 52 412 A1 to provide a releasable connection between wafers by means of a connecting material which melts as the temperature increases and which comprises one or more intermediate layers consisting of individual mono layers or molecule layers.

DE 0.101 37 376 A1 teaches that permanent bonds between wafers by means of specific bonding agents can be improved by the provision of thin layers of adhesion promoters, wherein, however, also this permanent bond is released at a temperature above 450° C.

The reference Eaton, W. P.; Subash, H. R.; Smith, R. L: “Silicon wafer-to-wafer bonding at T<200° C. with polymethylmethacrylate” in Applied Physics Letters, ISSN 0003-6951, 1994, vol. 65, no. 4, pages 439 to 441 teaches the bonding of oxidized silicon wafers by a thermoplastic PMMA as a planarizing layer.

The reference Lin, H. C.; Chang, K. L.; Pickrell, G. W.; Hsieh, K. C.; Cheng, K. Y.: “Low temperature wafer bonding by spin on glass” in J. Vac. Sci. Technol. B, ISSN 1071-1023, 2002, vol. 20, no. 2, pages 752 to 754 discloses SOG bonding of two wafers by means of siloxane and silicate.

The reference Marazita, S. M.; Bishop, W. L.; Hesler, J. L.; Hui, K.; [et al.]: “Integrated GaAs Schottky Mixers by Spin-on-Dielectric Wafer Bonding” in IEEE Transactions on Electron Devices, ISSN 0018-9383, 2000, vol. 47, no. 6, pages 1152 to 11.57 explains wafer bonding and the used SOG and SOD materials as well as their application as a planarizing agent.

In DE 2 425 993 A1 oxidized silicon wafers are bonded by means of a glass binding layer, wherein their softening point can be adjusted by the boron content but lies above 850° C.

In JP-07-192980 A a duroplastic polyimide is used for bonding coated wafers that are not releasable under the influence of heat.

U.S. Pat. No. 6,287,891 B1 discloses that during thinning of a waver which is bonded to a carrier by means of wax, a protective photoresist layer is provided between wax and wafer, wherein the bond is released as the wax dissolves.

It is therefore the object of the present invention to provide an improved method for temporarily fixing two planar workpieces, in particular a processed wafer and a carrier wafer, said method solving the above-mentioned problem. In particular, in accordance with the present invention it is possible that the workpieces which are connected or bonded in accordance with the present invention can be separated from each other in a simple manner and without leaving any residues.

This problem is solved by the features of the claims.

In the method according to the present invention, first both the processed wafer and the carrier waver are coated with a thin layer, and subsequently the two coated sides of the substrates are connected by means of a bonding agent. Care should be taken that the thin layers can preferably be applied easily and removed without leaving any residues. The bonding agent, which actually causes the bond, needs only be selected with respect to its chemical resistance as well as its mechanical and adhesive properties. Aspects of cleaning the wafer after removal of the processed wafer from the carrier are not necessary because the bonding agent is not in direct contact with the wafers.

In the following, the invention will be described in more detail with reference to the attached drawings, wherein

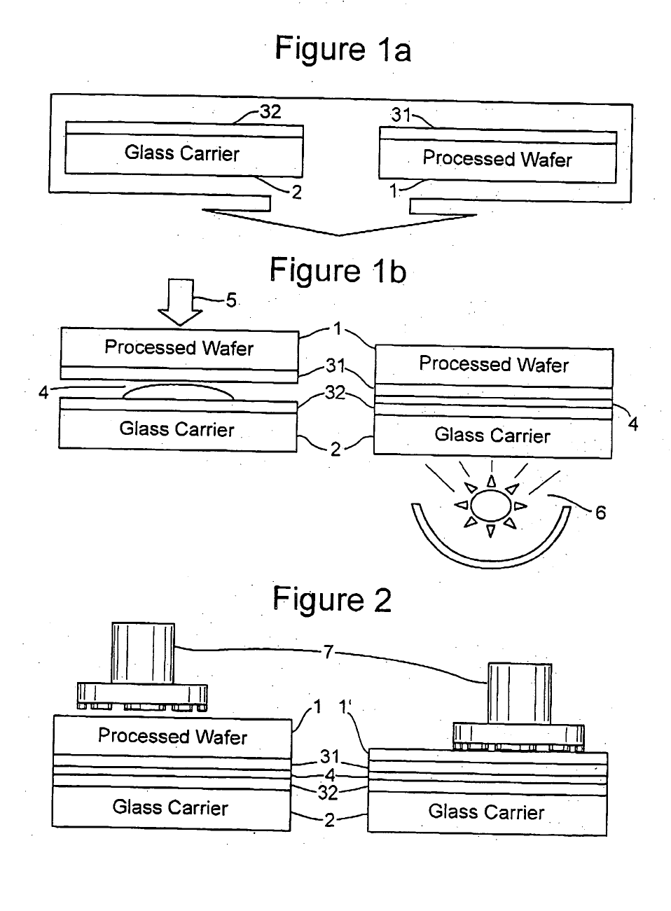

FIGS. 1 and 2 schematically show the steps of the method of the present invention.

FIG. 1 schematically shows the first step of the method of the present invention. At first, both the processed wafer 1 and the carrier wafer 2, which is generally a glass wafer, are coated with thin layers 31 and 32, respectively, i.e. the so-called release layers (see FIG. 1a). This is preferably done in a process common in the production of semiconductors, wherein substances common in the semiconductor industry such as, e.g., planarizing layers or protective coatings are used. These substances-are highly resistant to specific chemicals that are used in subsequent process steps, but in a defined solvent they dissolve well and without leaving any residues.

The two coated sides of the substrates are then connected to each other by means of a bonding, agent 4 (see FIG. 1b), which also exhibits a high resistance to the attack of chemicals used in the subsequent process steps but otherwise can be selected as desired. A negative photoresist or a generally common ultraviolet curing adhesive is preferably used for this purpose. The connection can be-caused in different ways. FIG. 1(b) exemplarily shows a squeezing process. The squeezing force is applied in the direction of the arrow 5 of FIG. 1(b). The ultraviolet sensitive bonding agent 4 is then exposed to light supplied by an exposure lamp 6 through the glass wafer 2.

The thus created wafer stack can then be thinned. FIG. 2 exemplarily shows a grinding process in which a grinding device 7 is used. After the treatment of the back side of the processed wafer is completed, i.e. after the processed wafer was reduced to the required thickness by means of the intended grinding, lapping and etching processes, carrier wafer and processed wafer can be separated in a wet chemical process without leaving any residues, because in the course of the wet chemical treatment only the two release layers 31 and 32 are attacked by the solvent. With the wet chemical treatment, the bonding agent 4, which actually causes the bond, is left over as waste.

In sum, the present invention provides a method allowing a temporary bond between two planar workpieces, said bond consisting of arbitrarily selectable anaerobically curing bonding agents and being easily releasable by means of a wet chemical process and without leaving residues. The two release layers 31 and 32 can be applied easily and removed again without leaving any residues. The bonding agent 4, which actually causes the bond, needs only be selected with respect to its chemical resistance as well as its mechanical and adhesive properties. Specific aspects of wafer cleaning after separation of processed wafer 1 and carrier wafer 2 are not necessary. With the method of the present invention, ultraviolet curing adhesives can be used for the first time.

1. A method for temporarily, releasably connecting a processed wafer (1) and a carrier wafer (2), wherein a thin layer (31, 32) is applied to the sides of said wafers to be connected, and the thus coated sides are connected by means of a bonding agent (4), characterized in that the thin layers (31, 32) are dissolved in a defined solvent in order to release the temporary connection.

2. The method according to claim 1, characterized in that the thin layers (31, 32) are dissolved in the defined solvent without leaving any residues but exhibit a high resistance to other chemicals used.

3. The method according to claim 1, wherein the carrier wafer (2) is a glass wafer.

4. The method according to claim 1, wherein an ultraviolet curing adhesive is used as the bonding agent (4).

5. The method according to claim 1, wherein a negative photoresist is used as the bonding agent (4).

6. The method according to claim 3, wherein an exposure is caused by an exposure means (6) through the glass wafer (2).

7. The method according to claim 1, wherein the connection is caused by a squeezing process.
